(19) United States
(12) Patent Application Publication
(10) Pub. No.: US 2010/0169289 A1
(43) Pub. Date: Jul. 1, 2010

(54) Two Phase Commit With Grid Elements

(75) Inventors: William T. Newport, Rochester, MN (US); John Joseph Stecher, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 12/345,722

(22) Filed: Dec. 30, 2008

(51) Int. Cl. G06F 17/30

(52) U.S. Cl. 707/705; 707/E17.009

(57) ABSTRACT

A method, storage medium, and computer that, in an embodiment, receive a command that specifies a transaction identifier, keys, and partition identifiers. A primary partition is selected that executes on a first server. The first server comprises a first grid element that includes a first row that is identified by an initial key. An identification of the first grid element, the transaction identifier, an identifier of the primary partition, and the initial key are stored in a primary factory point at the first server. A secondary partition that executes on a second server is found. The second server comprises a second grid element that includes a second row that is identified by a second key. An identification of the second grid element, the transaction identifier, an identifier of the secondary partition, and the second key are stored in a secondary factory point at the second server.

### FIELD

This invention generally relates to two phase commitment control in a distributed system of computers that stores data in grid elements.

### BACKGROUND

Computer systems typically include a combination of hardware, such as semiconductors and circuit boards, and computer programs. Fundamentally, computer systems are used for the storage and retrieval of data. Computer systems typically use transactions to change their data. While the transaction is in the process of changing the data, errors or other events can interrupt the transaction, resulting in the data being in an incomplete, inconsistent, unknown, or undesirable form. Therefore, it is desirable that transactions satisfy the following four fundamental properties: atomicity, consistency, isolation, and durability (ACID).

Atomicity means that the operations that make up a transaction are indivisible or atomic. That is, all operations that constitute a transaction must succeed for the transaction to succeed; conversely, if any individual operation within the transaction fails, the entire transaction as a whole also fails.

Consistency means that a transaction that changes data must ensure that the data remains in a consistent state, meaning that data integrity rules are not violated, regardless of whether the transaction succeeded or failed. Although the data might not be consistent at various times while the operations of the transaction are executing, the inconsistency is nonetheless invisible to other transactions, and consistency must be restored once the transaction completes.

Isolation determines the degree to which effects of multiple transactions, acting concurrently on the same data, are isolated from each other. Isolation is needed because until a transaction commits and a transaction boundary is reached, the changes to the data that the operations of a transaction makes are preliminary and not final, because the transaction might roll back the changes, which returns to the data to its original values that existed prior to the start of the transaction. If other transactions executing concurrently read intermediate data caused by a transaction in progress, then some of the intermediate data might be erroneous. Thus, the isolation property dictates how concurrent transactions that act on the same data behave.

The durability property of transactions refers to the fact that the effect of a transaction must endure beyond the life of a transaction and the application that requests the transaction. That is, changes to data made within a transactional boundary must be persisted onto permanent storage media, so that a change committed by one transaction is durable until another valid transaction changes the data.

The ACID properties of transactions may be implemented via the concept of a commit protocol, which uses commit and rollback operations. A commit operations makes a set of tentative changes permanent and available to be read by other transactions. A rollback operation is the opposite of a commit and undoes, discards, or deletes all the tentative or preliminary changes performed since the start of a transaction

Commit protocols become more complicated for global transactions, where a single transaction spans multiple resource managers or participants, and where the data upon which the global transaction operations is distributed across multiple computer systems. One technique for handling global transactions and distributed data is called a two-phase commit (2PC) protocol. The two-phase commit protocol ensures that either all participants in the global transaction commit their changes or none of them does. Once a transaction starts, it is said to be “in-flight.” If a failure occurs when the transaction is in-flight, the transaction is rolled back eventually.

During the first, or prepare phase of 2PC, a global coordinator inquires if all participants are prepared to commit their changes. The participants send their responses (their preparedness to commit) to the coordinator, which marks the state of the transaction for each participant as “in-doubt,” meaning that, at the end of the prepare phase, the state of the transaction is in-doubt because the changes of the transaction might be rolled back or they might be committed.

If all of the participants respond in the affirmative, indicating that they are prepared to commit the changes of the transaction, then the transaction progresses to the second, or commit phase, in which the coordinator asks all participants to commit their changes, and the participants perform commit processing, which makes the tentative changes to data permanent.

If even one of the participants responds in the negative, indicating that it is not prepared to commit the changes of the transaction, then the changes are rolled back.

Thus, in 2PC, a single location, the coordinator, knows the status of all in-flight and in-doubt transactions. In contrast to the single location of 2PC, grid computing replicates its data across multiple participants in order to provide high performance and high availability for transactions. Thus, the designers of grid computing do not want a single location for storing all in-flight transaction information because such a single location can potentially become a bottleneck on performance and availability.

### SUMMARY

A method, storage medium, and computer system are provided that, in an embodiment, receive a command from an application that specifies a transaction identifier, keys, and partition identifiers. A primary partition is selected that executes on a first server. The first server comprises a first grid element that includes a first row that is identified by an initial key. An identification of the first grid element, the transaction identifier, an identifier of the primary partition, and the initial key are stored in a primary factory point at the first server. A secondary partition that executes on a second server is found. The second server comprises a second grid element that includes a second row that is identified by a second key. An identification of the second grid element, the transaction identifier, an identifier of the secondary partition, and the second key are stored in a secondary factory point at the second server. The first grid element is copied to a replica grid element at a third server.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of selected components of the example system, according to an embodiment of the invention.

FIG. 3 depicts an example data structure for a factory point, according to an embodiment of the invention.

FIG. 4 depicts an example data structure for a replica of a factory point, according to an embodiment of the invention.

FIG. 5 depicts another example data structure for a factory point, according to an embodiment of the invention.

FIG. 6 depicts another example data structure for a factory point, according to an embodiment of the invention.

FIG. 7 depicts a flowchart of example processing for a transaction, according to an embodiment of the invention.

FIG. 8 depicts a flowchart of example processing for a commit command, according to an embodiment of the invention.

FIG. 9 depicts a flowchart of example processing for error handling, according to an embodiment of the invention.

FIG. 10 depicts a flowchart of example processing for creating replicas, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

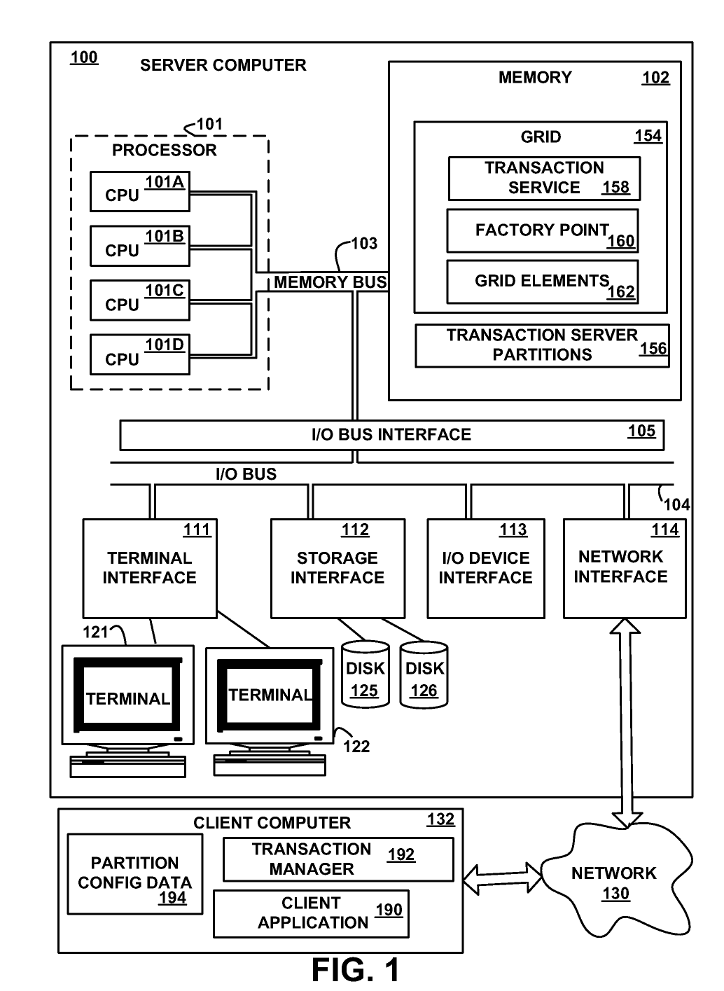

Referring to the Drawings, wherein like numbers denote like parts throughout the several views, FIG. 1 depicts a high-level block diagram representation of a server computer system 100 connected via a network 130 to client computer systems 132, according to an embodiment of the present invention. In an embodiment, the hardware components of the computer system 100 may be implemented by an eServer® iSeries® computer system. But, those skilled in the art will appreciate that the mechanisms and apparatus of embodiments of the present invention apply equally to any appropriate computing system. The terms “computer system,” “client,” and “server” are used for convenience only, and in other embodiments any appropriate electronic devices may be used, and a device that acts as a client in one scenario may act as a server in another scenario, and vice versa.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions or statements stored in the main memory 102 and may include one or more levels of on-board cache.

The main memory 102 is a random-access semiconductor memory that stores data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, the main memory 102 may exist in multiple levels of caches, and these caches may be further divided by function, so that one cache holds instructions while another holds non-instruction data, which is used by the processor or processors. The main memory 102 may be further distributed and associated with different CPUs or sets of CPUs, as is known in any of various so-called non-uniform memory access (NUMA) computer architectures.

The main memory 102 includes a grid 154 and one or more transaction server partitions 156. Although the grid 154 and the transaction server partitions 156 are illustrated as being contained within the memory 102 in the computer system 100, in other embodiments some or both of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the grid 154 and the transaction server partitions 156 are illustrated as being contained within the main memory 102, these elements are not necessarily all completely contained in the same storage device at the same time. Further, although the grid 154 and the transaction server partitions 156 are illustrated as being separate entities, in other embodiments some of them, or portions of some of them, may be packaged together.

The grid 154 includes a transaction service 158, a factory point 160, and grid elements 162. The transaction service 158 performs commit, rollback, and error processing functions for transactions using the grid elements 162. The factory point 160 describes the transactions that are executed at the server computer system 100.

The grid elements 162 store data. In an embodiment, the grid elements 162 are implemented as sets of tables, each of which is organized in a format of rows and columns. The rows (also known as tuples) of a table represent records (collections of information about separate items) and the columns represent fields (particular attributes about the separate items). A row is thus a set of attributes, and each row contains a data value for each of the column fields.

Each transaction server partition 156 is an independent routable unit of a server application that is capable of accepting work requests, accessing data stored in the grid 154, and performing functions in order to carry out the requests using the data stored in the grid elements 162. In various embodiments, the transaction server partition 156 may be a database partition, a storage partition, an operating system partition, a processor partition, a memory partition, a network partition, a cache partition, a user partition, or any other type of partition. A server application may be partitioned into the transaction server partitions 156 via a key-based partitioning technique, a hash-based partitioning technique, a combination of key-based partitioning and hash-based partitioning, or via any other appropriate technique.

In an embodiment, each transaction server partition 156 executes a separate operating system, but in other embodiments, all transaction server partitions 156 within a single server computer system 100 use the same operating system. The transaction server partitions 156 are statically or dynamically allocated the various resources in the physical computer (e.g., processors, memory, data structures, and input/output devices). For example, each transaction server partition 156 is allocated one or more processors 101, on which the transaction server partitions 156 execute, as well as a portion of the available memory space. In an embodiment, each transaction server partition 156 executes in a separate, or independent, memory space. In an embodiment, each transaction server partition 156 may share specific hardware resources, such as processors, so that a given processor is utilized by more than transaction server partition 156. In another embodiment, the hardware resources can be allocated to only one transaction server partition 156 at a time.

In an embodiment, the transaction server partitions 156 include routing tables that describe which of the transaction server partitions 156 are active on which of the server computer systems 100. The routing tables are updated to reflect the creation and deletion of the transaction server partitions 156, which are dynamically created and deleted.

The factory point 160 stores information about the transactions, including, e.g., the operations that the transaction performs, identifiers of the transactions, identifiers of the grid elements that the transactions access, optional data that the transactions write to the grid elements, identifiers of the transaction server partitions that execute the transactions, and keys and key values that the transactions use to access the data in the grid elements.

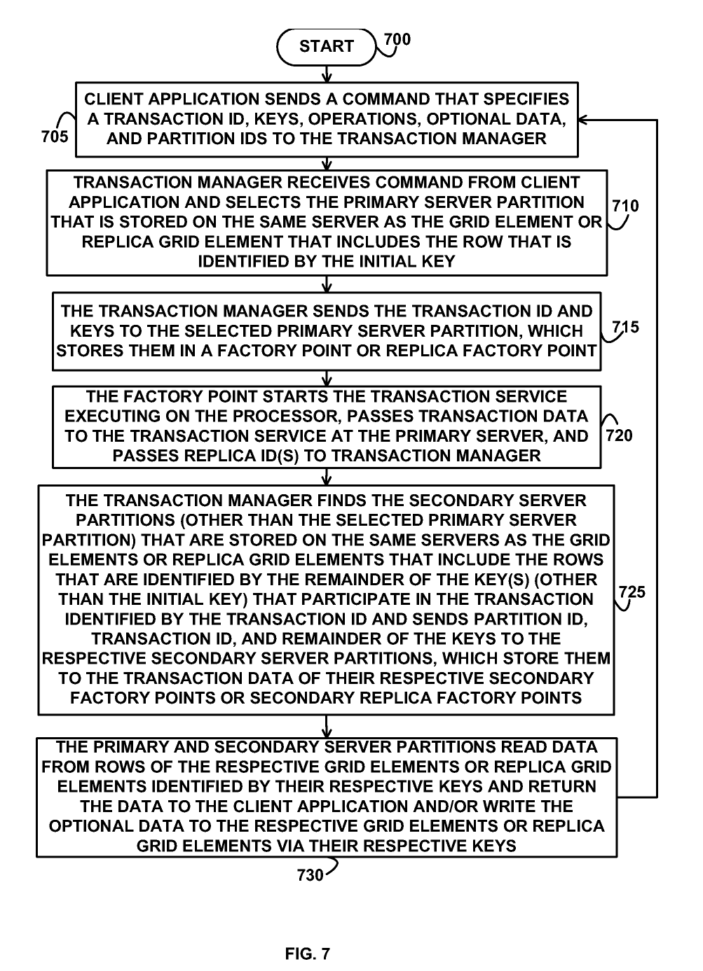

In an embodiment, the transaction server partitions 156 and/or the transaction service 158 include instructions that execute on the processor 101 or statements that are interpreted by instructions executing on the processor 101 to perform the functions as further described below with reference to FIGS. 7, 8, 9, and 10. In another embodiment, the transaction server partitions 156 and/or the transaction service 158 are implemented in microcode stored in a storage device. In another embodiment, the transaction server partitions 156 and/or the transaction service 158 are implemented in hardware via logic gates, circuits, chips, wires, electronic devices, cards, boards, and/or other appropriate hardware techniques in lieu of or in addition to a processor-based system.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology.

The I/O interface units 111, 112, 113, and 114 support communication with a variety of storage and I/O devices. For example, the terminal interface unit 111 supports the attachment of one or more user terminals 121 and 122. The user terminals 121 and 122 may include one or more user input and/or user output devices, such as a video display screen, a keyboard, a mouse, trackpad, a pointing device, a microphone, a speaker, any other input or output device, or any multiple or combination thereof. Users may enter and/or perceive data via operation of the user terminals 121 and 122 and their input and/or output devices.

The storage interface unit 112 supports the attachment of one or more direct access storage devices (DASD) 125 or 126 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125 and 126, as needed.

The I/O device interface 113 provides an interface to any of various other input/output devices or devices of other types, such as a printer, a fax machine, a bar code reader, or a scanner. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121 and 122, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

In various embodiments, the network 130 may represent a storage device or a combination of storage devices, either connected directly or indirectly to the computer system 100. In various embodiments, the network 130 may be implemented as a combination of connected computers, routers, servers, and/or other electronic devices.

The network 130 may be any suitable network or combination of networks and may support any appropriate protocol suitable for communication of data and/or code to/from the computer system 100. In an embodiment, the network 130 may support the INFINIBAND architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The client computers 132 may include some or all of the hardware and/or program components already described for the computer system 100. The client computers 132 include a client application 190, a transaction manager 192, and partition configuration data 194, which are stored in memory or a storage device analogous to the memory 102 and the disk 125 and which execute on a processor analogous to the processor 101. The client computers 132 send commands or requests and data to the server computer system 100 via the network 130 and receive responses and data from the sever 100 via the network 130. Although the client computers 132 are illustrated as separate from the computer system 100, in other embodiments, some or all of the client computers 132 may be a part of the computer system 100, e.g., implemented as applications stored and executing in the computer system 100. In various embodiments, the client application 190 comprises an operating system, a user application, a third party application or any other type of code stored in a storage device that executes on a processor. In another embodiment, the client application is implemented in hardware such as circuits or logic devices.

FIG. 1 illustrates the representative major components of the computer system 100, the network 130, and the client computers 132 at a high level; individual components may have greater complexity than represented in FIG. 1; components other than or in addition to those shown in FIG. 1 may be present; and the number, type, and configuration of such components may vary. Several particular examples of such additional complexity or additional variations are disclosed herein, but these are by way of example only and are not necessarily the only such variations.

The various program components illustrated in FIG. 1 and implementing various embodiments of the invention may be implemented in a number of manners, including using various computer applications, routines, components, programs, objects, modules, data structures, etc., referred to hereinafter as “computer programs,” or simply “programs.” The computer programs comprise one or more instructions or statements that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of storage medium used to actually carry out the distribution. The programs defining the functions of this embodiment may be stored in, encoded on, and delivered to the computer system 100 via a variety of tangible storage media, which include, but are not limited to the following computer-readable media:

(1) information permanently stored on a non-rewriteable storage medium, e.g., a read-only memory or storage device attached to or within a computer system, such as a CD-ROM, DVD-R, or DVD+R; or

(2) alterable information stored on a rewriteable storage medium, e.g., a hard disk drive (e.g., the DASD 125 or 126), CD-RW, DVD-RW, DVD+RW, DVD-RAM, or diskette.

Such tangible storage media, when carrying or encoded with computer-readable, processor-readable, or machine-readable instructions or statements that direct or control the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying systems and web services that implement, some or all of the methods described herein. Aspects of these embodiments may also include analyzing the client company, creating recommendations responsive to the analysis, generating programs to implement portions of the recommendations, integrating the programs into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or program environments may be used without departing from the scope of the invention.

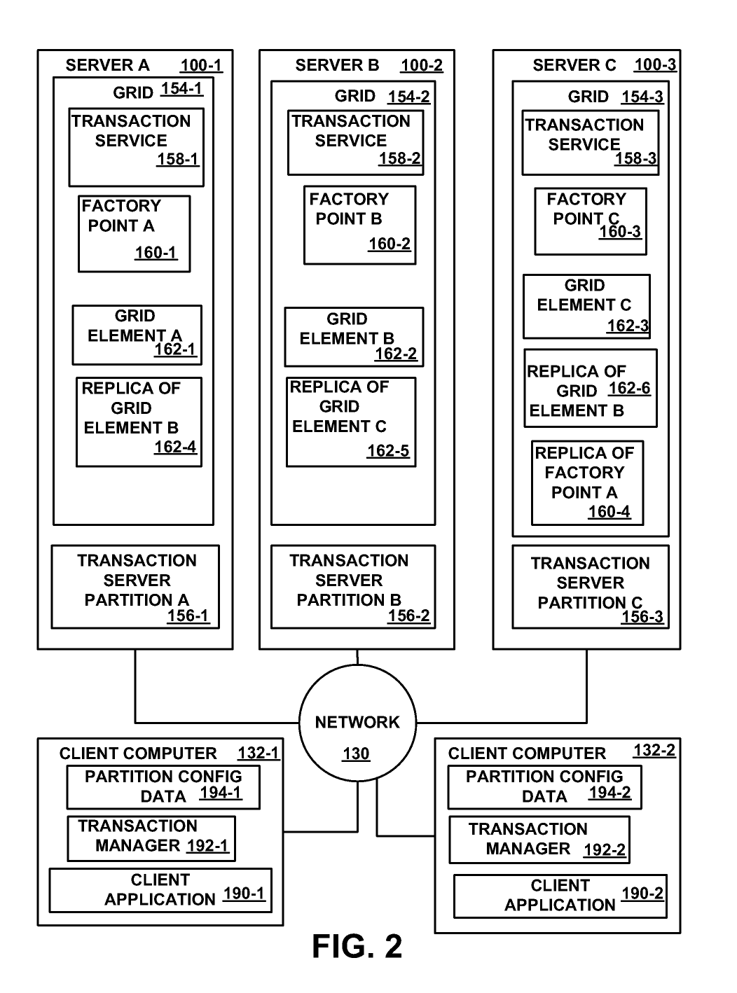

FIG. 2 depicts a block diagram of selected components of the example system, according to an embodiment of the invention. The example illustrated system includes the network 130 connected to the server computer systems 100-1, 100-2, and 100-3 and the client computer systems 132-1 and 132-2. The server computer systems 100-1, 100-2, and 100-3 are examples of the server computer system 100, as previously described above with reference to FIG. 1. The client computer systems 132-1 and 132-2 are examples of the client computer system 132, as previously described above with reference to FIG. 1.

The server computer system 100-1 includes a grid 154-1 and a transaction server partition 156-1. The grid 154-1 includes a transaction service 158-1, a factory point 160-1, 1, a grid element 162-1, and a replica grid element 162-4.

The server computer system 100-2 includes a grid 154-2 and a transaction server partition 156-2. The grid 154-2 includes a transaction service 158-2, a factory point 160-2, 2, a grid element 162-2, and a replica grid element 162-5.

The server computer system 100-3 includes a grid 154-3 and a transaction server partition 156-3. The grid 154-3 includes a transaction service 158-3, a factory point 160-3, 3, a grid element 162-3, a replica grid element 162-6, and a replica factory point 160-4.

The client computer 132-1 includes a client application 190-1, a transaction manager 192-1, and partition configuration data 194-1. The client computer 132-2 includes a client application 190-2, a transaction manager 192-2, and partition configuration data 194-2.

The data in the grid elements is partitioned across the grid elements 162-1, 162-2, and 162-3, meaning that not all of the data is stored at any one of the grid elements 162-1, 162-2, and 162-3, and the union of the grid elements 162-1, 162-2, and 162-3 represents the entirety of the data that is capable of being accessed by transactions. In various embodiments, the data is partitioned by row, by column, by table, by horizontal partitioning, or by vertical partitioning. Horizontal partitioning allows tables to be partitioned into disjoint sets of rows, which are physically stored and accessed separately in different data spaces. In contrast, vertical partitioning allows a table to be partitioned into disjoint sets of columns, which are physically stored and accessed separately in different data spaces.

The replica grid element 162-4 is a replica or a copy of the grid element 162-2. The replica grid element 162-5 is a replica or a copy of the grid element 162-3. The replica grid element 162-6 is a replica or a copy of the grid element 162-2. The replica factory point 160-4 is a replica or copy of the factory point 160-1. In general, replicas or copies of grid elements and factory points may exist on zero, one, or any number of other servers.

The transaction services 158-1, 158-2, and 158-3 at the respective servers 100-1, 100-2, and 100-3 optionally create and update one or more replicas of the grid elements and/or factory points that exist at the respective servers and send the replicas to other servers, where they are stored, in order to enable the repair of faults or errors in the data of the grid elements and/or factory points and in order to provide access to the data of the grid elements and/or factory points, in the event that one or more of the server computer systems 100-1, 100-2, or 100-3 experiences an error, loses data, or becomes temporarily or permanently unavailable. In various embodiments, the transaction services 158-1, 158-2, and 158-3 create, update, send, and store the replicas periodically, at check points or on a schedule, or in response to stimuli, such as changes to the factory points and grid elements.

The transaction services 158-1, 158-2, and 158-3 further determine whether a transaction server partition 156-1, 156-2, and 156-3 that processes a transaction accesses the data used by the transaction at a grid element or at a replica of the grid element if such a replica exists. The transaction services 158-1, 158-2, and 158-3 further determine whether a transaction server partition 156-1, 156-2, and 156-3 that processes a transaction accesses a factory point 160-1, 160-2, 160-3 or a replica of the factory point 160-4 if such a replica exists.

In various embodiments, the transaction services 158-1, 158-2, and 158-3 base their determinations on whether the grid element 162 or factory point 160 (or the server computer system 100 that stores the grid element 162 or factory point 160) is available, has not encountered an error, and/or has the performance or resource capacity that is necessary to process the transaction. For example, if the grid element 162 or factory point 160 (or the server computer system 100 that stores the grid element 162 or factory point 160) is available, has not encountered an error, and has the performance or resource capacity that is necessary to process the transaction, then the transaction service 158 chooses the grid element 162 or factory point 160 to process the transaction. But, if the grid element 162 or factory point 160 (or the server computer system 100 that stores the grid element 162 or factory point 160) is not available, has encountered an error, or does not have the performance or resource capacity to process the transaction, then the transaction service 158 chooses a replica grid element or factory point that is available, has not encountered an error, and has the performance or resource capacity necessary to process the transaction.

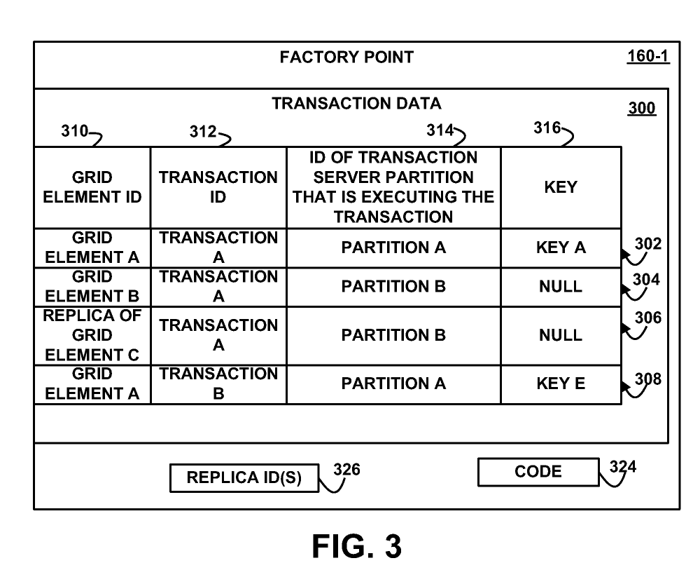

FIG. 3 depicts an example data structure for a factory point 160-1, according to an embodiment of the invention. The factory point 160-1 includes example transaction data 300, code 324, and replica identifier(s) 326. The example transaction data 300 includes example records 302, 304, 306, and 308, each of which includes an associated grid element identifier field 310, an associated transaction identifier field 312, an associated transaction server partition identifier field 314, and an associated key field 316.

In an embodiment, the code 324 includes instructions that execute on the processor 101 or statements that are interpreted by instructions that execute on the processor 101 to perform the functions as further described below with reference to FIGS. 7, 8, 9, and 10. In another embodiment, the code 324 is implemented in microcode stored in a storage device. In another embodiment, the code 324 is implemented in hardware via logic gates, circuits, chips, wires, electronic devices, cards, boards, and/or other appropriate hardware techniques in lieu of or in addition to a processor-based system.

The grid element identifier field 310 identifies the grid element 162 that is associated with the record. The transaction identifier field 312 identifies a transaction that accesses or reads/writes from/to the grid element identified by the associated grid element identifier field 310. The transaction server partition identifier field 314 identifies the transaction server partition 156 that is currently executing or will subsequently execute the transaction identified by the associated transaction identifier field 312.

The key field 316 specifies the key and/or key value that identifies a column and/or a row of data within the grid element identified by the associated grid element identifier 310. If the key field 316 specifies a non-null value, then the associated record (and its enclosing transaction data and factory point) are stored in the same server computer system 100 that stores the transaction server partition 156 specified by the transaction server identifier field 314 that is executing or that will execute the transaction specified by the associated transaction identifier 312. For example, since the record 302 includes a key field 316 that includes a non-null key of “key A,” then the transaction server “partition A” 156-1 specified in the associated transaction server partition identifier field 314 in the record 302 is executed by the same server 100-1 that stores the factory point 160-1, the transaction data 300, and the record 302. As another example, since the record 308 includes a key field 316 that includes a non-null key of “key E,” then the transaction server “partition A” 156-1 specified in the associated transaction server partition identifier field 314 in the record 308 is executed by the same server 100-1 that stores the factory point 160-1, the transaction data 300, and the record 308.

If the key field 316 specifies a null value, then the associated record (and its enclosing transaction data and factory point) in the transaction data 300 are stored in a different server than the server that stores the transaction server partition 156 specified by the transaction server identifier field 314 that executes the transaction specified by the associated transaction identifier 312. For example, since the record 304 includes a key field 316 that includes a null key, then the “partition B” 156-2 specified in the associated transaction server partition identifier field 314 in the record 304 is executed by a server 100-2 that is different from the server 100-1 that stores the factory point 160-1, the transaction data 300, and the record 304. As another example, since the record 306 includes a key field 316 that includes a null key, then the “partition B” 156-2 specified in the associated transaction server partition identifier field 314 in the record 306 is executed by a server 100-2 that is different from the server 100-1 that stores the factory point 160-1, the transaction data 300, and the record 306.

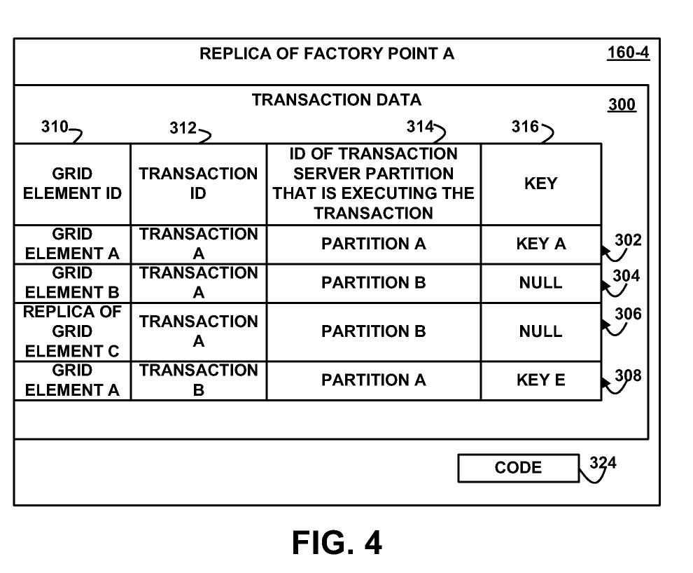

The replica identifier(s) 326 include the identifiers of the replica factory points that are copies or replicas of the factory point 160-1. For example, the replica identifier 326 in the factory point 160-1 stores an identifier of the replica factory point 160-4 (FIGS. 2 and 4) in the server 100-3 since the replica factory point 160-4 is a copy of the factory point 160-1. If the transaction manager 192 detects that the factory point and the server that stores the factory point are available, accessible, and have not encountered an error, then the transaction manager 192 communicates with, accesses, and uses the transaction data in the factory point and does not use the replica factory point. If the transaction manager 192 detects that the factory point has encountered an error or is unavailable or inaccessible or detects that the server that stores the factory point has encountered an error or is unavailable or inaccessible, then the transaction manager 192 finds the replica factory point that is identified by the replica identifier and communicates with, accesses, and uses the transaction data in the replica factory point and does not use the factory point.

FIG. 4 depicts an example data structure for a replica of a factory point, according to an embodiment of the invention. The replica factory point 160-4 is a replica or copy of the factory point 160-1 and includes the same transaction data 300 and the code 324 as does the factory point 160-1. The transaction data 300 includes the records 302, 304, 306, and 308, each of which include the grid element identifier field 310, the transaction identifier field 312, the transaction server partition identifier field 314, and the key field 316.

The key field 316 specifies the key and/or key value that identifies a column and/or a row of data within the grid element identified by the associated grid element identifier 310. If the key field 316 in the replica 160-4 specifies a non-null value, then the factory point 160-1 of which the replica 160-4 is a copy is stored in the same server computer system 100 that stores the transaction server partition 156 specified by the transaction server identifier field 314 that is executing or that will execute the transaction specified by the associated transaction identifier 312.

If the key field 316 specifies a null value, then the factory point 160-1 of which the replica 160-4 is a copy is stored in a different server than the server that stores the transaction server partition 156 specified by the transaction server partition identifier field 314 that executes the transaction specified by the associated transaction identifier 312.

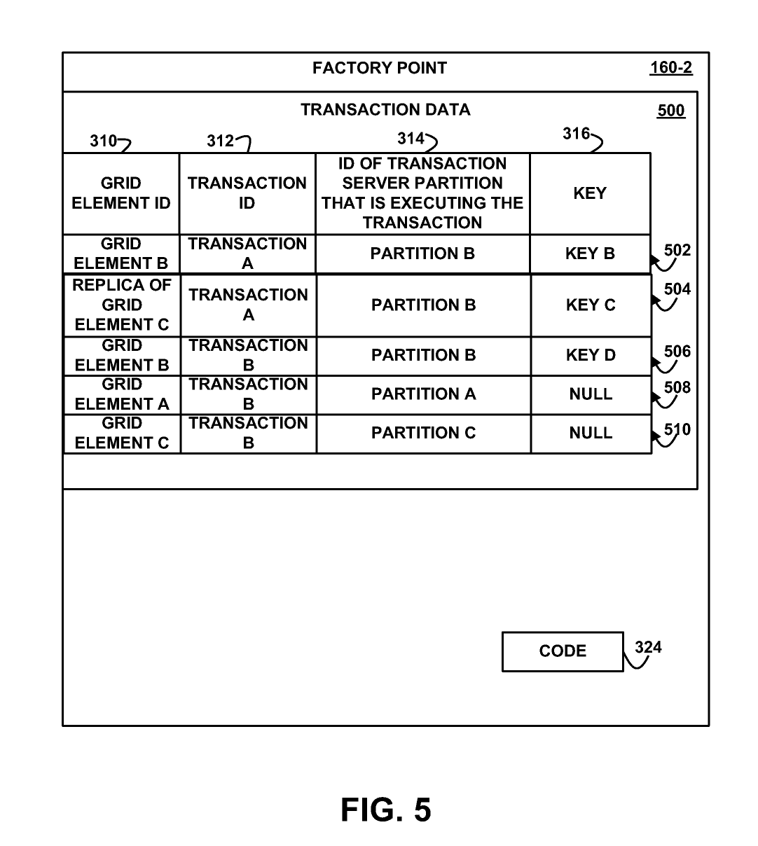

FIG. 5 depicts another example data structure for a factory point 160-2, according to an embodiment of the invention. The factory point 160-2 includes example transaction data 500 and code 324. The example transaction data 500 includes example records 502, 504, 506, 508, and 510, each of which includes an associated grid element identifier field 310, an associated transaction identifier field 312, an associated transaction server partition identifier field 314, and an associated key field 316.

In an embodiment, the code 324 includes instructions that execute on the processor 101 or statements that are interpreted by instructions that execute on the processor 101 to perform the functions as further described below with reference to FIGS. 7, 8, 9, and 10. In another embodiment, the code 324 is implemented in microcode stored in a storage device. In another embodiment, the code 324 is implemented in hardware via logic gates, circuits, chips, wires, electronic devices, cards, boards, and/or other appropriate hardware techniques in lieu of or in addition to a processor-based system.

The grid element identifier field 310 identifies the grid element 162 that is associated with the record. The transaction identifier field 312 identifies a transaction that accesses or reads/writes from/to the grid element identified by the associated grid element identifier field 310. The transaction server partition identifier field 314 identifies the transaction server partition 156 that is currently executing or will subsequently execute the transaction identified by the associated transaction identifier field 312.

The key field 316 specifies the key and/or key value that identifies a column and/or a row of data within the grid element identified by the associated grid element identifier 310. If the key field 316 specifies a non-null value, then the associated record (and its enclosing transaction data and factory point) are stored in the same server that stores the transaction server partition 156 specified by the transaction server identifier field 314 that is executing or that will execute the transaction specified by the associated transaction identifier 312.

For example, since the record 502 includes a key field 316 that includes a non-null key of “key B,” then the transaction server “partition B” 156-2 specified in the associated transaction server partition identifier field 314 in the record 502 is executed by the same server 100-2 that stores the factory point 160-2, the transaction data 500, and the record 502.

As another example, since the record 504 includes a key field 316 that includes a non-null key of “key C,” then the transaction server “partition B” 156-2 specified in the associated transaction server partition identifier field 314 in the record 504 is executed by the same server 100-2 that stores the factory point 160-2, the transaction data 500, and the record 504.

If the key field 316 specifies a null value, then the associated record (and its enclosing transaction data and factory point) in the transaction data 500 are stored in a different server than the server that stores the transaction server partition 156 specified by the transaction server identifier field 314 that executes the transaction specified by the associated transaction identifier 312.

For example, since the record 508 includes a key field 316 that includes a null key, then the “partition A” 156-1 specified in the associated transaction server partition identifier field 314 in the record 508 is executed by a server 100-1 that is different from the server 100-2 that stores the factory point 160-2, the transaction data 500, and the record 508.

As another example, since the record 510 includes a key field 316 that includes a null key, then the “partition C” 156-3 specified in the associated transaction server partition identifier field 314 in the record 510 is executed by a server 100-3 that is different from the server 100-2 that stores the factory point 160-2, the transaction data 500, and the record 510.

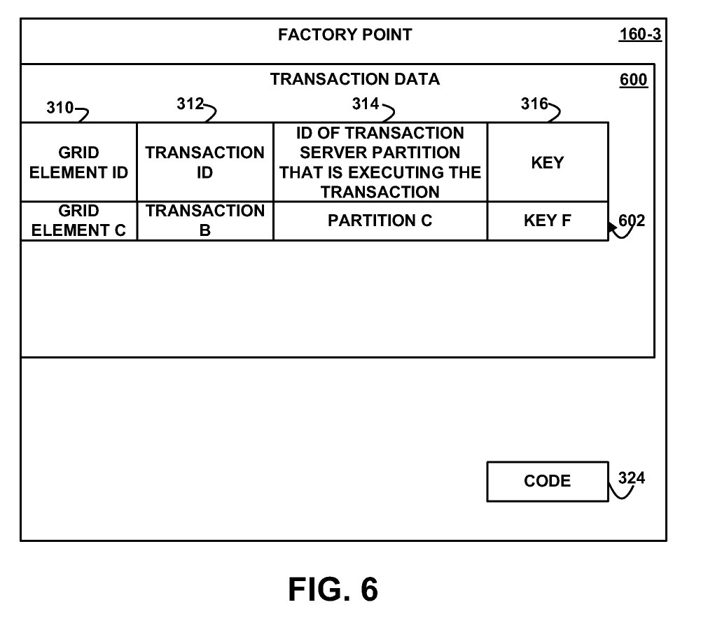

FIG. 6 depicts an example data structure for a factory point 160-3, according to an embodiment of the invention. The factory point 160-3 includes example transaction data 600 and code 324. The example transaction data 600 includes an example record 602, which includes an associated grid element identifier field 310, an associated transaction identifier field 312, an associated transaction server partition identifier field 314, and an associated key field 316.

In an embodiment, the code 324 includes instructions that execute on the processor 101 or statements that are interpreted by instructions that execute on the processor 101 to perform the functions as further described below with reference to FIGS. 7, 8, 9, and 10. In another embodiment, the code 324 is implemented in microcode stored in a storage device. In another embodiment, the code 324 is implemented in hardware via logic gates, circuits, chips, wires, electronic devices, cards, boards, and/or other appropriate hardware techniques in lieu of or in addition to a processor-based system.

The grid element identifier field 310 identifies the grid element 162 that is associated with the record. The transaction identifier field 312 identifies a transaction that accesses or reads/writes from/to the grid element identified by the associated grid element identifier field 310. The transaction server partition identifier field 314 identifies the transaction server partition 156 that is currently executing or will subsequently execute the transaction identified by the associated transaction identifier field 312.

The key field 316 specifies the key and/or key value that identifies a column and/or a row of data within the grid element identified by the associated grid element identifier 310. If the key field 316 specifies a non-null value, then the associated record (and its enclosing transaction data and factory point) are stored in the same server that stores the transaction server partition 156 specified by the transaction server partition identifier field 314 that is executing or that will execute the transaction specified by the associated transaction identifier 312.

For example, since the record 602 includes a key field 316 that includes a non-null key of “key F,” then the transaction server “partition C” 156-3 specified in the associated transaction server partition identifier field 314 in the record 602 is executed by the same server 100-3 that stores the factory point 160-3, the transaction data 600, and the record 602.

FIG. 7 depicts a flowchart of example processing for a transaction, according to an embodiment of the invention. Control begins at block 700. Control then continues to block 705 where the client application 190 sends a command that specifies a transaction identifier, one or more operations, one or more keys and key values, optional data, and one or more partition identifiers to the transaction manager 192. Each key identifies a column in a grid element or a replica grid element, and each of the key values comprises a data value that uniquely identifies a row within that identified column of the grid element or replica grid element.

Control then continues to block 710 where the transaction manager 192 receives the command from the client application 190, and as a result and in response, selects the primary server partition (from among all of the server partitions) that includes the grid element or replica grid element that includes the row that is identified by the initial or first key and associated key value in an ordered sequence of received keys and associated key values. In various embodiments, the order of the ordered sequence is specified by the client application 190 or by the transaction manager 192. In another embodiment, the order of the ordered sequence, or the order of a portion of the ordered sequence, is random.

In an embodiment, the data in the rows that are specified by keys and key values that are later in the ordered sequence are dependent on or use the data specified by the keys and key values that are earlier in the ordered sequence. In another embodiment, the operations that are performed by the transaction on the data in the rows that are specified by keys and key values that are later in the ordered sequence are dependent on the result of operations that are performed on the data specified by the keys and key values that are earlier in the ordered sequence. For example, if a transaction reads first and second data from first and second rows in first and second grid elements (or replica grid elements), adds the first and second data, and writes the sum of the first and second data to a third row in a third grid element (or replica grid element), then the write operation of the sum is dependent on the read operations of the first and second data, which must be performed before the write operation because the transaction server partitions 156 do not know the sum to write until after the read operations have been performed. That is, the later operations use the output of an earlier operation as input.

Control then continues to block 715 where the transaction manager 192 sends the transaction identifier, the operations, the key(s), and the key value(s) to the selected primary server partition, which receives and stores the transaction identifier, the operations, the key(s) and the key value(s) in the factory point or the replica factory point of the selected server partition as a record in the transaction data of the factory point or the replica factory point.

Control then continues to block 720 where, in response to the store of the record in the transaction data, the factory point or the replica factory point at the primary server starts the transaction service 158 executing on the processor of the primary server and passes the stored transaction data to the transaction service 158, which receives the transaction data. The factory point 160 further sends the identifiers of the replica factory points 326 (if any) that identify the replica factory points that are replicas or copies of the factory point to the transaction manager.

Control then continues to block 725 where the transaction manager 192 finds the secondary server partitions (other than the selected primary server partition) that are stored on the same servers as the respective grid element(s) or the replica grid element(s) that include the rows that are identified by the remainder of the key(s) and associated key value(s) (other than the initial key) that participate in the transaction identified by the transaction identifier. The transaction manager 192 further sends the partition identifier, the transaction identifier, and the remainder of the key(s) and associated key value(s) to the respective secondary server partitions that include the grid elements(s) or the replica grid element(s) that include the rows identified by the respective remainder of the key(s) and associated key value(s), which store them to the transaction data of their respective secondary factory points or secondary replica factory points.

Control then continues to block 730 where the primary and the secondary server partitions perform the operations, read data from the rows of their respective grid elements or replica grid elements identified by their respective keys and key values (both initial and remainder) and return the read data to the application, and/or write the optional data to the respective grid elements that are identified by their respective keys and associated key values. If the grid elements are available and have not encountered an error, the primary and secondary server partitions perform the operations by accessing the grid elements and reading and/or writing data to the grid elements; otherwise, the primary and server partitions perform the operations by accessing the replica grid elements and reading and/or writing data to the replica grid elements.

Control then returns to block 705 where the logic of FIG. 7 executes again to process a subsequent command from the same or a different client application.

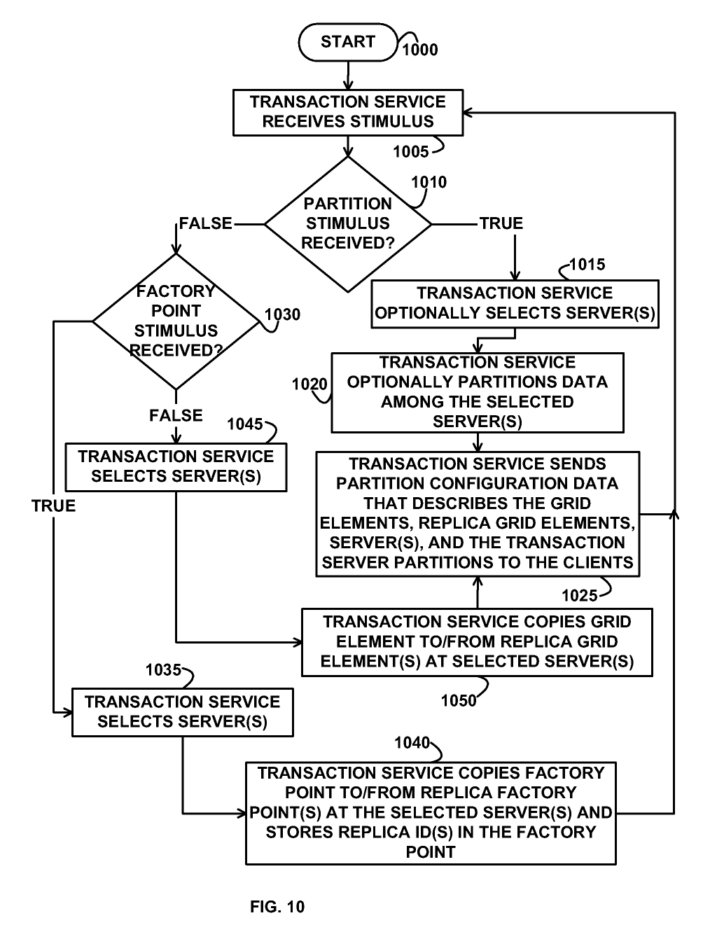

The transaction manager 192 selects either the transaction server partition that is stored on a same server as a grid element or the transaction server partition 156 that is stored on a same server as a replica of the grid element based on the partition configuration data 194, which the transaction manager 192 receives from a transaction service 158, as further described below with reference to FIG. 10. The partition configuration data 194 specifies the transaction server partitions 156 that are available at various of the servers and the keys and ranges of key values that are stored at the servers where the server partitions are stored. That is, the partition configuration data 194 specifies how the data is partitioned across the grid elements and the replica grid elements, including specifying which row and columns (identified by the keys and ranges of key values) are available at which server.

The transaction manager 192 does not need to know whether the rows and columns that it desires to access are stored in a grid element or a replica of a grid element; instead, the transaction manager 192 chooses a transaction server partition 156 that is stored at a server that also stores a key and range of key values that matches the key and key value that the client application 190 desires to access, as specified by the command that the client application 190 sent to the transaction manager 192. That is, the key specified by the client application 190 matches a key specified by the partition configuration data 194 and the key value specified by the client application 190 falls within a range of key values specified by the partition configuration data 194. In an embodiment, the partition configuration data 194 also includes selected information from the transaction data of the factory point or replica factory point that specifies which of the servers includes a primary factory point or primary replica factory point.

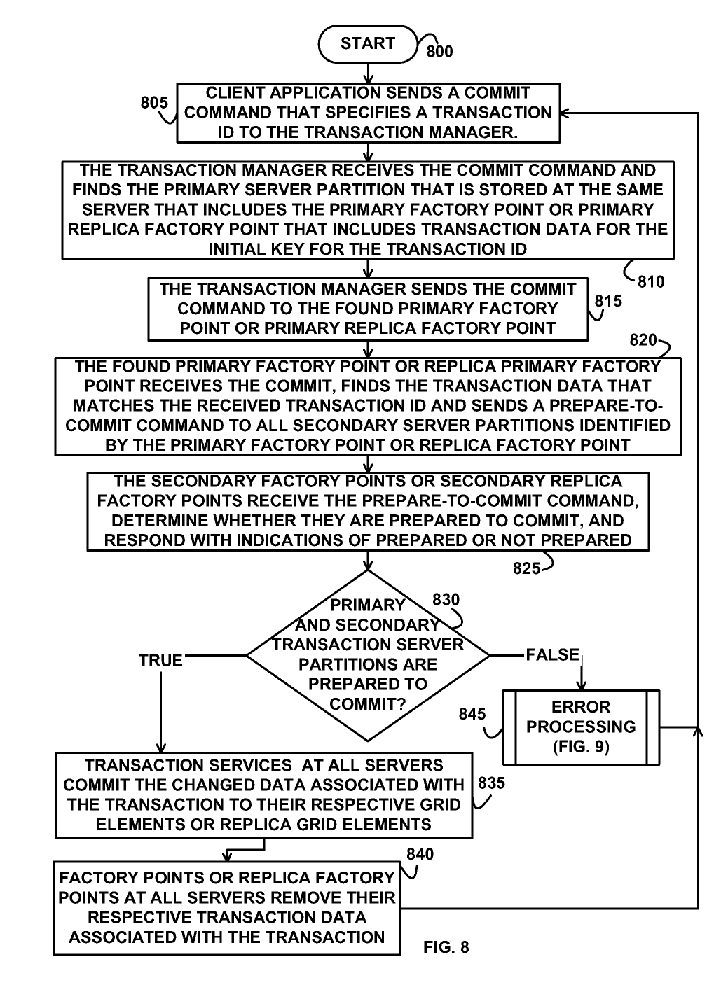

FIG. 8 depicts a flowchart of example processing for a commit command, according to an embodiment of the invention. The logic of FIG. 8 is executed once for every commit command that is sent by a client application. Control begins at block 800.

Control then continues to block 805 where the client application 190 sends a commit command that specifies a transaction identifier to the transaction manager 192. The transaction identifier matches a transaction identifier that was previously specified by a command, as previously described above with reference to FIG. 7.

Control then continues to block 810 where the transaction manager 192 receives the commit command and, in response to and as a result of receiving the commit command, the transaction manager 192 finds the primary server partition that is stored on the same server as the primary factory point (if the primary factory point and its server are available and capable of being connected to and the primary factory point and its server have not encountered an error) or the primary replica factory point (if the primary replica factory point and its server are available and capable of being connected to and the primary replica factory point and its server have not encountered an error) that includes the transaction data for the initial key for the transaction identifier. That is, the transaction manager 192 finds the server that stores transaction data that includes a record with a transaction identifier field 312 that stores a transaction identifier that matches the transaction identifier specified by the commit command, and that record has a non-null key and key value specified in the key field 316, and that transaction data also includes other record(s) having transaction identifier field(s) 312 that match the transaction identifier specified by the commit command, and those other records have key field(s) 316 that are null. In an embodiment, the transaction manager 192 finds the primary server partition by reading and searching the partition configuration data 194.

Control then continues to block 815 where the transaction manager 192 sends the commit command to the found primary factory point or found primary replica factory point. Control then continues to block 820 where the primary factory point or primary replica factory point receives the commit command, finds its transaction data records with transaction identifier fields 312 that match the transaction identifier specified by the commit command, and in response sends a prepare-to-commit command that specifies the transaction identifier to all of the secondary transaction server partitions (which have null values in the key field 316 in the primary factory point that is stored in the primary server of the primary transaction server partition) specified by the transaction server partition identifier field 314 in the found records.

Control then continues to block 825 where the secondary factory points or secondary replica factory points receive the prepare-to-commit command, and in response determine whether their associated transaction server partitions 156 (stored on the same server) are prepared to commit the transaction, and respond with indications of prepared or not prepared. The primary factory point or primary replica factory point also determines whether its associated transaction server partition 156 (stored on the same server) is prepared to commit the transaction. In various embodiments, a transaction server partition 156 is prepared to commit a transaction if the transaction server partition 156 is executing and has not encountered an error, if the grid element or replica grid element that the transaction server partition 156 accesses is not in an error state, and if the operation that the transaction server partition 156 performed as part of the transaction against the grid element or replica grid element completed successfully.

Control then continues to block 830 where the primary or replica factory point determines whether all of the primary and secondary transaction server partitions 156 that perform operations as a part of the transaction are prepared to commit the transaction. If the determination at block 830 is true, then all of the primary and secondary server partitions that perform operations as a part of the transaction are prepared to commit the transaction, so control continues to block 835 where the transaction services 158 at all of the primary and secondary server partitions commit, or make permanent, the changed data associated with the transaction to their respective grid elements or replica grid elements. Data that has been committed is available for other transactions to retrieve. Data that has not been committed is not available for other transactions to retrieve.

Control then continues to block 840 where all of the factory points or replica factory points at all servers that have records in their transaction data that specify the transaction identifier that was specified by the commit command remove those respective records from the transaction data of their respective factory points or replica factory points. Control then returns to block 805 where the logic of FIG. 8 executes again to process a subsequent commit command that specifies a different transaction from the same or a different client application 190.

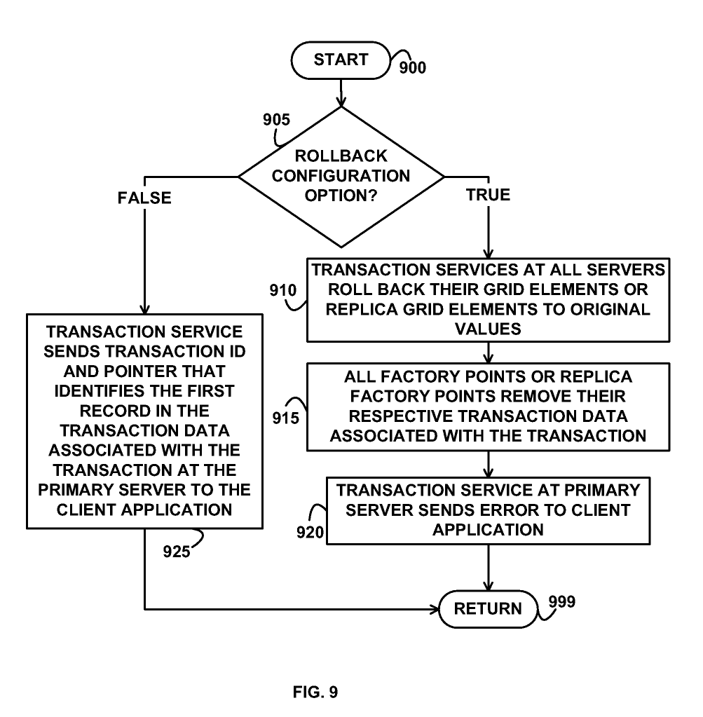

If the determination at block 830 is false, then all of the server partitions that are involved in the transaction are not prepared to commit the changes specified by the operations of the transaction, so control continues to block 845 where error processing is performed, as further described below with reference to FIG. 9. Control then returns to block 805 where the logic of FIG. 8 executes again to process a subsequent commit command from the same or a different client application 190.

FIG. 9 depicts a flowchart of example processing for error handling, according to an embodiment of the invention. Control begins at block 900. Control then continues to block 905 where the transaction service 158 determines whether a rollback configuration option is specified. In various embodiments, the rollback configuration option may be specified by the client application 190 on the commit command, may be specified by any other appropriate command from the client application 190 or the transaction manager 192, may be specified by the factory point or the replica factory point, may be specified by transaction service 158, or may be entered by a user via the user terminal 121 or 122.

If the determination at block 905 is true, then the rollback configuration option is specified, so control continues to block 910 where the transaction services 158 associated with all transaction server partitions 156 that performed operations as a part of the transaction roll back the data in their respective grid elements or replica grid elements to be the original values of the respective grid elements or the replica grid elements that existed prior to the operations of the transaction. Control then continues to block 915 where the primary and secondary factory points or the primary and secondary replica factory points remove their records from their respective transaction data that specify the transaction identifier that was specified by the commit command.

Control then continues to block 920 where the transaction server partition at the primary server that stores the primary transaction server partition 156 and the primary factory point or primary replica factory point sends an error to the client application 190 that indicates that the data specified by the transaction was not committed to the grid element or the replica grid element. Control then continues to block 999 where the logic of FIG. 9 returns.

If the determination at block 905 is false, then the rollback configuration option is not specified, so control continues to block 925 where the transaction service 158 sends the transaction identifier and a pointer that identifies the first record in the transaction data that is associated with the transaction at the primary server to the client application 190. The client application 190, transaction manager 192, or other service or application rolls back the operations of the transaction at a future time. Control then continues to block 999 where logic of FIG. 9 returns.

FIG. 10 depicts a flowchart of example processing for creating replicas, according to an embodiment of the invention. In various embodiments, the logic of FIG. 10 is executed concurrently with the logic of FIGS. 7 and 8, interspersed with the execution logic of FIGS. 7 and 8, or subsequent to the execution of the logic of FIGS. 7 and 8.

Control begins at block 1000. Control then continues to block 1005 where the transaction service 158 receives or detects a stimulus. In various embodiments, the transaction service 158 receives or detects a stimulus periodically, at times specified by a schedule, or in response to operations, functions, or actions performed by the transaction server partitions 156, the transaction mangers 192, or the client applications 190.

In various embodiments, the stimulus is a partition stimulus, a factory point stimulus, or a grid stimulus. In various embodiments, a grid stimulus is the creation of a grid element or a replica grid element, an insertion of data into a grid element or replica grid element, a change of the data that is stored at a grid element or replica grid element, or a receipt of a command from a user interface terminal, from a transaction manager 192, from a client application 190, or from any other programmatic entity that requests that a grid element be replicated or moved between servers.

In various embodiments, a partition stimulus is the receipt of a command from a user interface terminal, from a transaction manager 192, from a client application 190, or from any other programmatic entity that requests that data be partitioned among grid elements or that the partitioning of data among the grid elements be changed. In another embodiment, a partition stimulus is a determination by the transaction service 158 or by another programmatic element that the partitioning of the data needs to be changed. The determination that the partitioning of the data needs to be changed may be made in response to a detection that performance of transaction server partition 156 falls below a threshold, in response to a detection that the number of transactions performed by a transaction server partition 156 exceeds or is less than a threshold, or by a detection that the amount of data stored at a grid element exceeds a threshold or is less than a threshold.

In various embodiments a factory point stimulus is the receipt of a command from a user interface terminal, from a transaction manager 192, from a client application 190, or from any other programmatic entity that requests that a factory point be replicated or moved between server computer systems. In another embodiment, a factory point stimulus is a determination by the transaction service 158 or by another programmatic element that a factory point needs to be replicated or moved between server computer systems. The determination that a factory point needs to be replicated or moved between servers may be made in response to a detection that performance at a transaction server partition 156 falls below a threshold, in response to a detection that the number of transactions performed by a transaction server partition 156 exceeds a threshold or is less than a threshold, or by a detection that the amount of data stored at a factory point exceeds a threshold or is less than a threshold.

Control then continues to block 1010 where the transaction service 158 determines whether the stimulus that was received or detected is a partition stimulus.

If the determination at block 1010 is true, then the received or detected stimulus is a partition stimulus, so control continues to block 1015 where the transaction service 158 optionally selects one or more servers. Control then continues to block 1020 where the transaction service 158 optionally partitions data among the grid elements and replica grid elements of the selected server(s) or changes the partitioning of the data among the grid elements or replica grid elements of the selected servers, including moving data between servers. Control then continues to block 1025 where the transaction service 158 sends partition configuration data 194 that describes the grid elements, replica grid elements, server(s), the transaction server partitions 156, and the keys and range of key values that exists at each grid element and replica grid element to the client computers 132. Control then returns to block 1005 where the transaction service 158 waits for and ultimately receives and begins processing another stimulus, as previously described above.

If the determination at block 1010 is false, then the stimulus that was received was not a partition stimulus, so control continues to block 1030 where the transaction service 158 determines whether the stimulus that was received or detected is a factory point stimulus.

If the determination at block 1030 is true, then the received or detected stimulus is a factory point stimulus, so control continues to block 1035 where the transaction service 158 selects one or more servers. Control then continues to block 1040 where the transaction service 158 copies the factory point that is stored at the same server as the transaction service 158 to replica factory point(s) at the one or more selected servers or copies a replica factory point that is stored at the same server as the transaction service 158 to the factory point for which the replica factory point is a replica at the selected server. The transaction service 158 further stores the identifiers of the replica factory points(s) into the associated factory point of which the replica factory points are a replica or copy, e.g., as the replica identifiers 326 (FIG. 3). Control then returns to block 1005 where the transaction service 158 waits for and ultimately receives and begins processing another stimulus, as previously described above.

If the determination at block 1030 is false, then the received or detected stimulus is a grid stimulus, so control continues to block 1045 where the transaction service 158 selects one or more servers. Control then continues to block 1050 where the transaction service 158 copies the grid element that is stored at the same server as the transaction service 158 to a replica grid element at the one more selected servers or copies a replica grid element that is stored at the same server as the transaction service 158 to the grid element for which the replica grid element is a replica at the selected server. Control then continues to block 1025 where the transaction service 158 sends partition configuration data 194 that describes the grid elements, replica grid elements, server(s), the transaction server partitions 156, and the keys and range of key values that are stored at the grid elements and replica grid elements to the client computers 132. Control then returns to block 1005 where the transaction service 158 waits for and ultimately receives and begins processing another stimulus, as previously described above.

In this way, an embodiment of the invention provides virtualized grid computing that is compatible with a two phase commit protocol and presents a single factory point to a client application for the storing of in-flight and in-doubt transaction information while still providing scalability, availability, and performance without needing to pre-register a static set of transaction server partitions.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Any data structures and data values are examples only and other organizations of data and data values may be used. In other embodiments, some or all of the data structures and data values do not exist in separate form, but are instead combined with programmatic code or circuit elements. Where single elements or components are illustrated, multiple numbers of elements and components may be used. Where multiple numbers of elements or components are illustrated and described, single elements or components or any number of elements or components may be used. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
receiving a first command from an application, wherein the first command specifies a transaction identifier, a plurality of keys, and a plurality of partition identifiers;
selecting a primary partition that executes on a first server, wherein the first server comprises a first grid element that includes a first row that is identified by an initial key of the plurality of keys;
storing an identification of the first grid element, the transaction identifier, an identifier of the primary partition, and the initial key in a primary factory point at the first server;
finding a secondary partition that executes on a second server, wherein the second server comprises a second grid element that includes a second row that is identified by a second key of the plurality of keys;
storing an identification of the second grid element, the transaction identifier, an identifier of the secondary partition, and the second key in a secondary factory point at the second server; and
copying the first grid element to a replica grid element at a third server.

2. The method of claim 1, wherein a second operation that accesses the second grid element via the second key is dependent on a result of a first operation that accesses the first grid element via the first key.

3. The method of claim 1, further comprising
copying the primary factory point to a replica factory point at the third server.

4. The method of claim 3, further comprising:
receiving a commit command that specifies the transaction identifier from the application; and
if the primary factory point is available, sending a prepare-to-commit command to the secondary partition that is identified by the primary factory point.

5. The method of claim 4, further comprising:
if the primary factory point is not available, sending the prepare-to-commit command to the secondary partition that is identified by the primary replica factory point.

6. The method of claim 5, further comprising:
if the primary partition and the secondary partition are prepared to commit and the first grid element and the second grid element are available, committing changed data to the first grid element and the second grid element.

7. The method of claim 6, further comprising:
if the primary partition and the secondary partition are prepared to commit and the first grid element is not available, committing the changed data to the replica grid element.

8. A storage medium encoded with instructions, wherein the instructions when executed comprise:
receiving a first command from an application, wherein the first command specifies a transaction identifier, a plurality of keys, and a plurality of partition identifiers;
selecting a primary partition that executes on a first server, wherein the first server comprises a first grid element that includes a first row that is identified by an initial key of the plurality of keys;
storing an identification of the first grid element, the transaction identifier, an identifier of the primary partition, and the initial key in a primary factory point at the first server;
finding a secondary partition that executes on a second server, wherein the second server comprises a second grid element that includes a second row that is identified by a second key of the plurality of keys;
storing an identification of the second grid element, the transaction identifier, an identifier of the secondary partition, and the second key in a secondary factory point at the second server; and
copying the first grid element to a replica grid element at a third server.

9. The storage medium of claim 8, wherein a second operation that accesses the second grid element via the second key is dependent on a result of a first operation that accesses the first grid element via the first key.

10. The storage medium of claim 8, further comprising
copying the primary factory point to a replica factory point at the third server.

11. The storage medium of claim 10, further comprising:
receiving a commit command that specifies the transaction identifier from the application; and
if the primary factory point is available, sending a prepare-to-commit command to the secondary partition that is identified by the primary factory point.

12. The storage medium of claim 11, further comprising:
if the primary factory point is not available, sending the prepare-to-commit command to the secondary partition that is identified by the primary replica factory point.

13. The storage medium of claim 12, further comprising:
if the primary partition and the secondary partition are prepared to commit and the first grid element and the second grid element are available, committing changed data to the first grid element and the second grid element.

14. The storage medium of claim 13, further comprising:
if the primary partition and the secondary partition are prepared to commit and the first grid element is not available, committing the changed data to the replica grid element.

15. A computer system comprising:
a processor; and
memory connected to the processor, wherein the memory is encoded with instructions, wherein the instructions when executed on the processor comprise:
receiving a first command from an application, wherein the first command specifies a transaction identifier, a plurality of keys, and a plurality of partition identifiers,
selecting a primary partition that executes on a first server, wherein the first server comprises a first grid element that includes a first row that is identified by an initial key of the plurality of keys,
storing an identification of the first grid element, the transaction identifier, an identifier of the primary partition, and the initial key in a primary factory point at the first server,
finding a secondary partition that executes on a second server, wherein the second server comprises a second grid element that includes a second row that is identified by a second key of the plurality of keys, wherein a second operation that accesses the second grid element via the second key is dependent on a result of a first operation that accesses the first grid element via the first key,
storing an identification of the second grid element, the transaction identifier, an identifier of the secondary partition, and the second key in a secondary factory point at the second server, and
copying the first grid element to a replica grid element at a third server.

16. The computer system of claim 15, wherein the instructions further comprise:
copying the primary factory point to a replica factory point at the third server.

17. The computer system of claim 16, wherein the instructions further comprise:
receiving a commit command that specifies the transaction identifier from the application; and
if the primary factory point is available, sending a prepare-to-commit command to the secondary partition that is identified by the primary factory point.

18. The computer system of claim 17, wherein the instructions further comprise:
if the primary factory point is not available, sending the prepare-to-commit command to the secondary partition that is identified by the primary replica factory point.

19. The computer system of claim 18, wherein the instructions further comprise:
if the primary partition and the secondary partition are prepared to commit and the first grid element and the second grid element are available, committing changed data to the first grid element and the second grid element.

20. The computer system of claim 19, wherein the instructions further comprise:
if the primary partition and the secondary partition are prepared to commit and the first grid element is not available, committing the changed data to the replica grid element.
